(19) United States
(12) Patent Application Publication
(10) Pub. No.: US 2015/0102197 A1
(43) Pub. Date: Apr. 16, 2015

(54) ELECTRONIC DEVICE STAND

(71) Applicant: SABIC Global Technologies B.V., Bergen op Zoom (NL)

(72) Inventors: Arunachala Parameshwara, Bangalore (IN); Poovanna Theethira Kushalappa, Bangalore (IN); Thomas Hocker, Concord Parkway, MA (US); Bhushan Deshmukh, Bangalore (IN)

(21) Appl. No.: 14/511,714

(22) Filed: Oct. 10, 2014

Related U.S. Application Data
(60) Provisional application No. 61/889,605, filed on Oct. 11, 2013.

(51) Int. Cl. A47B 23/04; F16M 11/18

(52) U.S. Cl. CPC A47B 23/043; F16M 11/18
USPC 248/450; 248/460

(57) ABSTRACT

A stand for holding a device comprising: a base; a first support member oriented in a vertical direction in operable communication with the base; a second support member oriented in a horizontal direction in operable communication with the first support member; wherein the second support member comprises at least one retaining member angled away from the second support member in a vertical direction; wherein at least one of the base, first support member, and second support member comprises an adjustment mechanism allowing for the adjustment of the location of the retaining member; wherein the stand comprises a one-piece unit.

### CROSS REFERENCE TO RELATED APPLICATIONS

This application claims the benefit of U.S. Provisional Patent Application Ser. No. 61/889,605 filed Oct. 11, 2013. The related application is incorporated herein by reference.

### BACKGROUND OF THE INVENTION

This disclosure relates to stands and in particular to stands for personal electronic devices, methods of manufacture, and uses thereof.

Stands for personal electronic devices can be complicated and rely on user assembly. One-piece stands that are rigid may not allow for the adjustment of the stand as desired. Previous attempts to produce an adjustable stand involved multiple parts to interact to provide adjustability. However, such multiple piece approaches can have drawbacks. An undesirably large number of pieces can add complexity that can exacerbate manufacturing error by increasing the chance for part incompatibility and by increasing opportunities for incorrect assembly. If the stand is to be assembled prior to shipment, such an approach can add to manufacturing time and expense. Because variances in manufacturing processes can result in pieces that function poorly together or become incompatible, simplified assemblies are desired.

There accordingly remains a need in the art for a stand that reduces assembly effort while allowing for improved adjustability.

### SUMMARY OF THE INVENTION

Disclosed herein are stands for electronic devices, methods of manufacture, and uses thereof.

In an embodiment, a stand for holding a device comprising: a base; a first support member oriented in a vertical direction in operable communication with the base; a second support member oriented in a horizontal direction in operable communication with the first support member; wherein the second support member comprises at least one retaining member angled away from the second support member in a vertical direction; wherein at least one of the base, first support member, and second support member comprises an adjustment mechanism allowing for the adjustment of the location of the retaining member; wherein the stand comprises a one-piece unit.

The above described problems and solutions as well as other features and solutions are exemplified by the following detailed description.

### BRIEF DESCRIPTION OF THE DRAWINGS

FIG. 1 is an isometric view of a stand for according to an embodiment.

FIG. 2 is cross sectional isometric view of the stand of FIG. 1

FIG. 3 is a bottom view of the stand of FIG. 1.

FIG. 4 is a rear view of the stand of FIG. 1

FIG. 5 is an isometric view of a stand according to an embodiment.

FIG. 6 is a cross sectional isometric view of the stand of FIG. 5.

FIG. 7 is a cross sectional isometric rear view of the stand of FIG. 5.

FIG. 8 is an isometric view of a stand according to an embodiment.

FIG. 9 is a cross sectional view of the stand of FIG. 8.

FIG. 10 is an isometric view of a stand according to an embodiment.

FIG. 11 is a cross sectional view of the stand of FIG. 10.

FIG. 12 is a side view of an embodiment of the stand illustrating the movement of the retaining member.

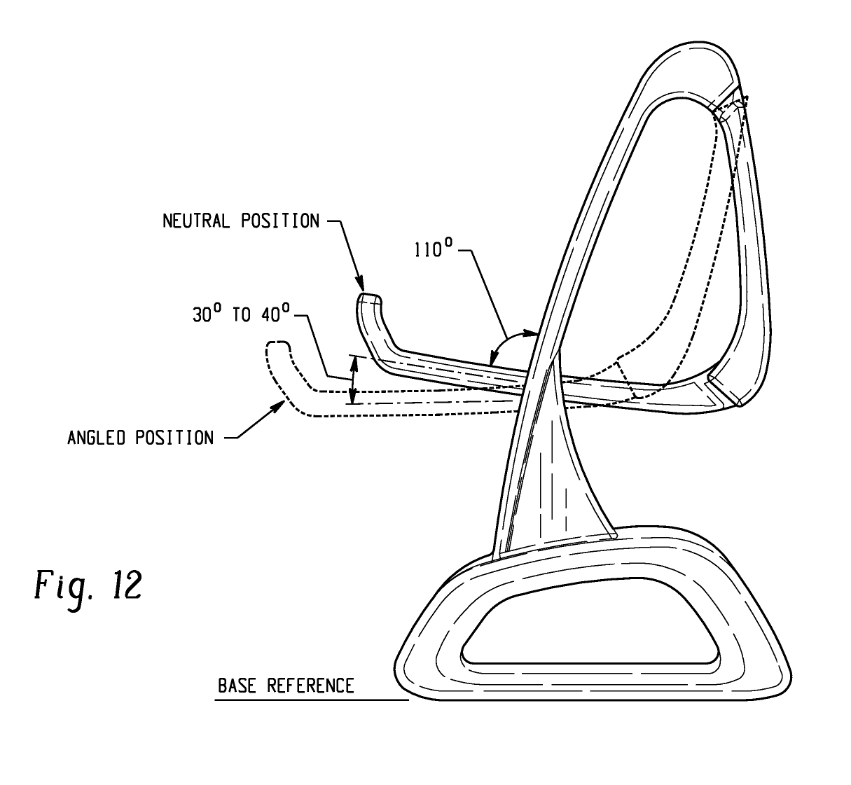

### DETAILED DESCRIPTION OF THE INVENTION

Without being bound by theory, it is believed that the favorable results obtained herein, e.g., an adjustable, one-piece stand for an electronic device, can be made through an additive manufacturing process.

The term “electronic device” as used herein refers to at least one of a digital music player, a digital video player, a cellular phone (e.g., smartphone), a personal digital assistant, a handheld digital computer (e.g., a calculator, a tablet personal computer, a netbook computer, or a portable gaming console), or another device with the capability to display images, text, and/or videos.

The stand can be manufactured with an additive manufacturing process. Additive manufacturing processes, or three dimensional (3-D) printing, are generally defined as processes that build a solid object from a series of layers with each layer formed on top of the previous layer. For example, 3-D printing refers to a variety of processes including Material Extrusion, Fused Deposition Modeling (FDM) or Fused Filament Fabrication (FFF), Selective Laser Sintering (SLS), Direct Metal Laser Sintering (DMLS), Electron Beam Freeform Fabrication (EBF³), Electron Beam Melting (EBM), Laminated Object Manufacturing (LOM), Stereolithography (SLA), and Digital Light Processing (DLP).

Material Extrusion, Fused Deposition Modeling (FDM) and/or Fused Filament Fabrication (FFF) can involve building a part or article layer-by-layer by heating thermoplastic material to a semi-liquid state and extruding it according to computer-controlled paths. FDM can use a modeling material and a support material. The modeling material can comprise the finished piece, and the support material can comprise scaffolding that can be washed away or dissolved when the process is complete. The process can involve depositing material to complete each layer before the base moves down the Z-axis and the next layer begins.

Selective Laser Sintering (SLS) can involve sintering of very fine powders layer by layer from the bottom up until the product is completed. The process can begin by the input of one or more data files such as a 3-D CAD file and, a control program to convert the CAD files into instructions to control the layer by layer formation of the metal parts. The layer by layer formation can be accomplished by laser sintering a first layer onto a platform. The platform can then lower and a fresh layer of powder can be swept over the previously sintered layer, and the next layer can be sintered or added on top of the previously formed layer. SLS can utilize a wide variety of materials including plastic, metal (direct metal laser sintering), ceramic, and/or glass powders. Unlike Material Extrusion, FDM or FFF, SLS does not require the use of a support material.

Direct Metal Laser Sintering (DMLS) is a subset of SLS involving the use of powdered metal materials, and in particular metal alloys. For example, DMLS can utilize 17-4 and 15-5 stainless steel, maraging steel, cobalt chromium, inconel 625 and 718, and titanium (e.g., Ti6Al4V) as building materials.

Electron Beam Melting (EBM) is a process that utilizes fully dense metal components that can be built up, layer by layer, of metal powder, which can then be melted by a powerful electron beam. Each layer can be melted to the exact geometry defined by a CAD model. The process can take place in vacuum and at high temperature, resulting in stress relieved components with material properties better than cast and comparable to wrought material.

Electron Beam Freeform Fabrication (EBF³) can use a focused electron beam in a vacuum environment to create a molten pool on a metallic substrate. The beam can be translated with respect to the surface of the substrate while metal wire can be fed into the molten pool. The deposit solidifies immediately after the electron beam has passed, generating a sufficient structural strength to support itself. The sequence can be repeated in a layer-additive manner to produce a near-net-shape part requiring only finish machining. In an EBF³ process, a design drawing of a three-dimensional (3D) object may be sliced into different layers as a preparatory step, with the electron beam tracing each of the various layers within a vacuum chamber. The layers ultimately cool into a desired complex or 3D shape.

Stereolithography (SLA) can use a photopolymer resin that can be selectively hardened by a laser beam delivering UV light at desirable spots on each thin resin layer.

Laminated Object Manufacturing (LOM) laminates can cut sheets of a special paper to create 3D parts. Layers of adhesive-coated paper, plastic, or metal laminates can be successively glued together and cut to shape with a knife or laser cutter.

Digital Light Processing (DLP) exposes photopolymer filled with ceramic powder to light from a digital light processing (DLP) projector. The light can harden the mix materials and a layer of the object can be therefore created. After every layer the Z-platform can move up and the lighting process for a new layer can start until the desired shape is formed.

Depending on the additive process used, the stand can be made from a variety of materials including polymeric materials, ceramics, glass, and metallic alloys.

The stand can include various polymeric materials. Polymeric materials can include thermoplastics, thermosets, elastomers, as well as combinations comprising at least one of these. Some examples of thermoplastics include polycarbonate (PC), acrylonitrile butadiene styrene (ABS), acrylic, celluloid, cellulose acetate, ethylene-vinyl acetate (EVA), ethylene vinyl alcohol (EVOH), fluoroplastics, ionomers, acrylic-polyvinyl chloride (e.g., Kydex™), liquid crystal polymer (LCP), polyacetal (POM or acetal), polyacrylates (acrylic), polyacrylonitrile (PAN or acrylonitrile), polyamide (PA or nylon), polyamide-imide (PAI), polyaryletherketone (PAEK or ketone), polybutadiene (PBD), polybutylene (PB), polybutylene terephthalate (PBT), polycaprolactone (PCL), polychlorotrifluoroethylene (PCTFE), polyethylene terephthalate (PET), polycyclohexylene dimethylene terephthalate (PCT), polyhydroxyalkanoates (PHAs), polyketone (PK), polyester, polyethylene (PE), polyetheretherketone (PEEK), polyetherketoneketone (PEKK), polyetherimide (PEI), polyethersulfone (PES), polysulfone, polyethylenechlorinates (PEC), polyimide (PI), polylactic acid (PLA), polymethylpentene (PMP), polyphenylene oxide (PPO), polyphenylene sulfide (PPS), polyphthalamide (PPA), polypropylene (PP), polystyrene (PS), polysulfone (PSU), polyphenylsulfone, polytrimethylene terephthalate (PTT), polyurethane (PU), polyvinyl acetate (PVA), polyvinyl chloride (PVC), polyvinylidene chloride (PVDC), and styrene-acrylonitrile (SAN), as well as combinations comprising at least one of the foregoing.

Examples of thermoset materials can include unsaturated polyester, phenolic, epoxy, urethane, urea, and vinyl ester resins, and combinations comprising at least one of the foregoing.

Alumina, zirconia, zircon (i.e., zirconium silicate), and silicon carbide are representative ceramic materials.

Powdered metals can be any powdered metal available on the market capable of being sintered and includes, but is not limited to, 303 stainless steel, 304 stainless steel, 431 stainless steel, 432 stainless steel, iron, copper, bronze, aluminum, tungsten, chromium-cobalt alloy, titanium and titanium alloys, or similar materials and combinations comprising at least one of the foregoing.

The use of an additive manufacturing process advantageously allows for a one-piece stand that can be adjusted using moving parts without the necessity of assembly. For example, additive manufacturing can produce a stand with moving parts that cannot be assembled from separate components and cannot be disassembled without damaging or destroying the stand.

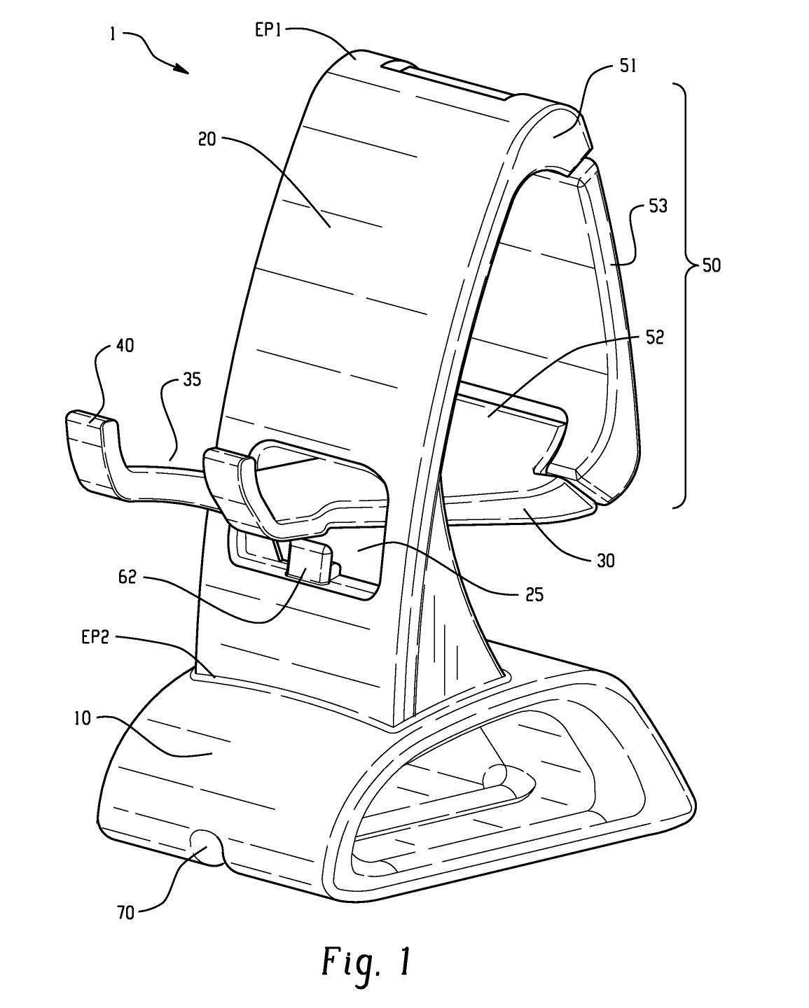

As shown in FIG. 1, a one-piece stand 1 comprises several components including base 10 and vertical support member 20 (also referred to as first support member). Vertical support member 20 can be substantially vertical. In other words, vertical support member 20 can deviate from a vertical plane by about 45° in either direction when measured from one endpoint to the other endpoint. For example, with reference to FIG. 1, endpoint EP1 is located at the top of vertical support member 20, and endpoint EP2 is located at the intersection of vertical support member 20 and base 10. A line joining endpoint EP1 with endpoint EP2 can be substantially vertical (e.g., within −45° to 45° from a vertical plane passing through EP1). Vertical support member 20 can be curved, planar, or a combination thereof.

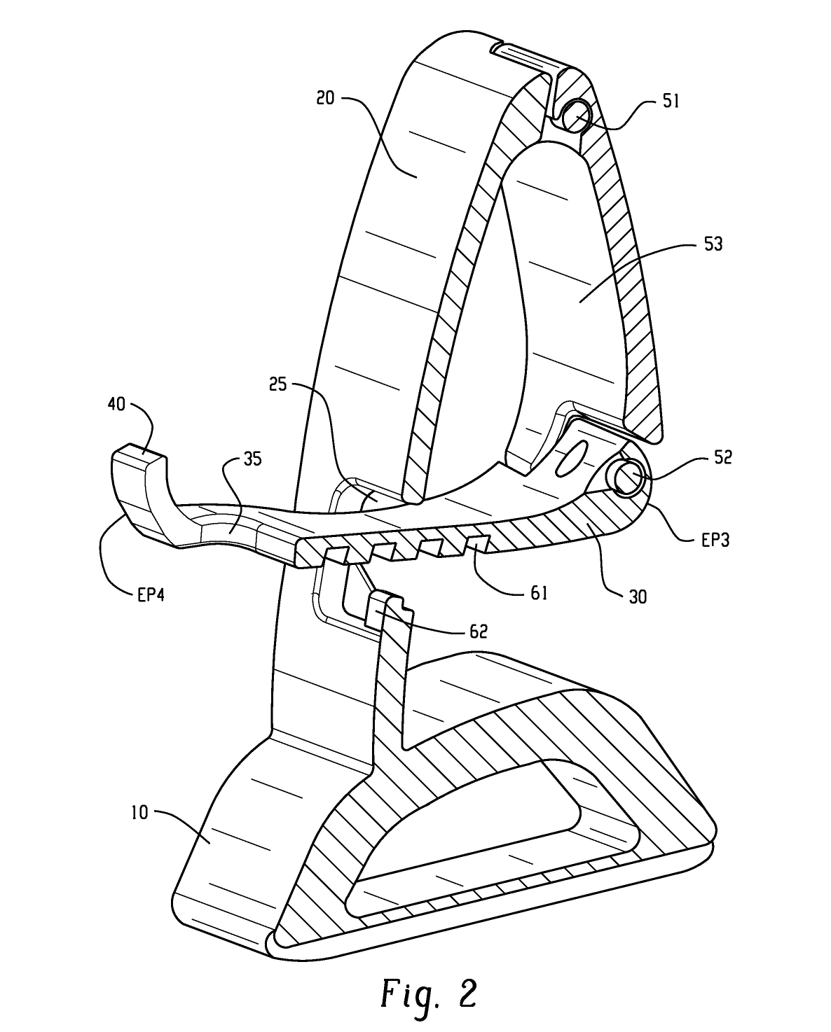

The one-piece stand 1 can also comprise a horizontal support member 30 (also referred to as second support member) that can be substantially horizontal. In other words, horizontal support member 30 can deviate from a vertical plane by about 45° in either direction when measured from one endpoint to the other endpoint. For example, with reference to FIG. 2, a line joining endpoint EP3 with endpoint EP4 can be substantially horizontal (e.g., within −45° to 45° from a horizontal plane passing through EP3). Horizontal support member 30 can be curved, planar, or a combination thereof.

In operative communication with the vertical support member can be a base 10. As shown in FIG. 1, horizontal support member 30 is in operable communication with vertical support member 20 through adjustment mechanism 50, which, as shown in FIG. 1, comprises hinges 51, 52 (also known as first hinge and second hinge) and connection arm 53 (also referred to as connecting member).

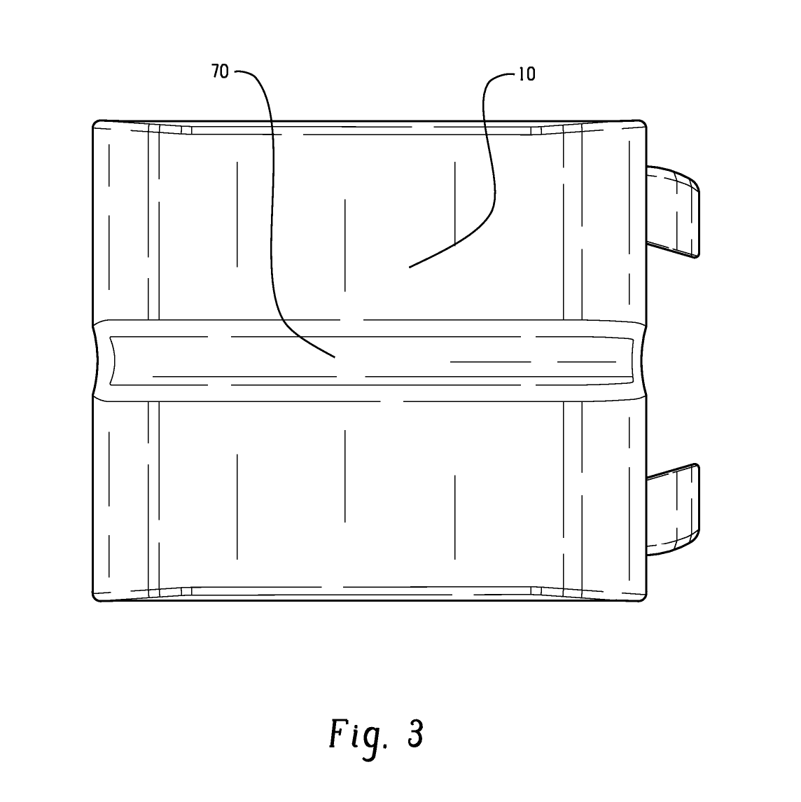

Horizontal support member 30 can include retaining member 40 on its free end. As shown in FIG. 1, retaining member 40 can be angled away from the remainder of horizontal supporting member 30, so as to hold a device in place. For example, retaining member 40 can act as a lip to prevent a device from sliding off horizontal support member. The free end of horizontal support member 30 can also include an aperture 35, which can be fully enclosed or “U” shaped. Aperture 35 advantageously allows for a cord, such as a power cord, to connect to the device while it is supported by the stand. The free end of horizontal support member 30 and/or retaining member 40 can include a securing mechanism for further retaining the device in place. For example, suction cups (e.g., microsuction cups), a layer (e.g., that adds surface texture to increase friction if the device moves, that has adhesive properties, and/or that has elastomeric properties), a groove (e.g., that can receive an end of the device), and combinations comprising at least one of the foregoing can be used as securing mechanisms. In addition, as shown in FIG. 3, base 10 can include notch 70 extending from the front of the base to the rear of the base, which can advantageously allow a cord to pass from the device through aperture 35 and under base 10.

One or more of the components described above can incorporate a wireless charging capability. For example, vertical support member 20, horizontal support member 30, and/or retaining member 40 can include wireless charging capability. Base 10 can include a power source, such as a battery or operative connection to a power supply (e.g., a wall outlet).

One or more of the components described above can include a wired charging capability. For example, base 10 can include a power source such as a battery or can have a power cord (e.g., that can be arranged in operative communication with a power supply such as a wall outlet). One or more of horizontal support member 30, vertical support member 20, and/or retaining member 40 can include a wire leading to a connection for charging an electronic device. For example, a wire can be incorporated from base 10, through a portion of vertical support member 20 and a portion of horizontal support member 30, terminating at aperture 35 with a connection mechanism configured to connect to an electronic device.

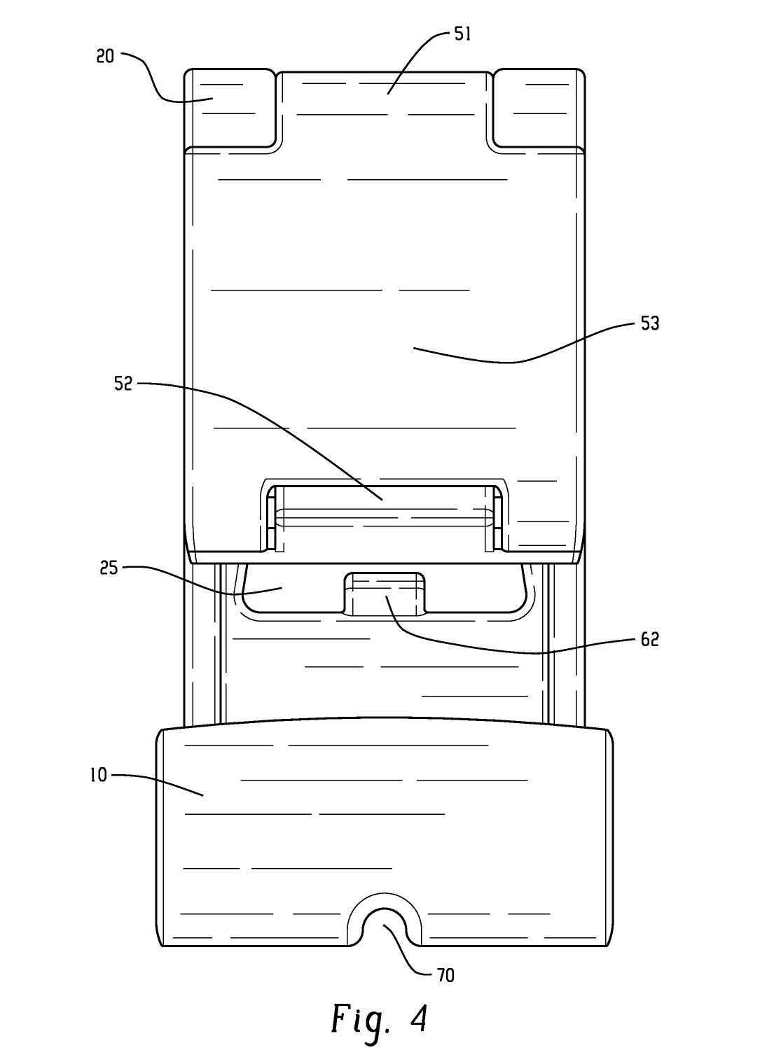

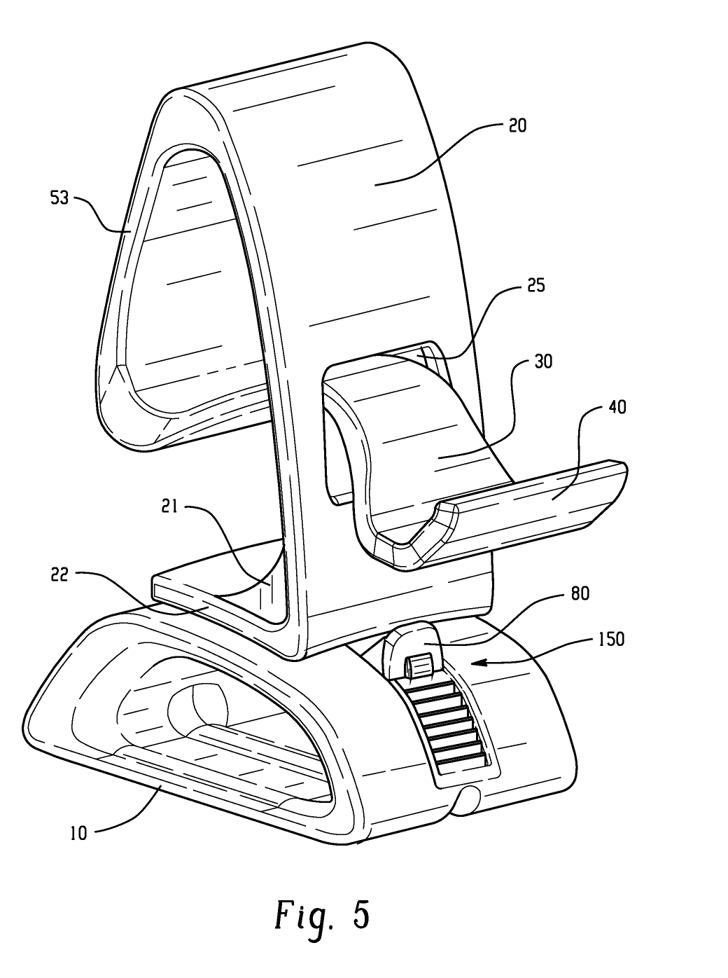

FIG. 1 illustrates adjustment mechanism 50 comprises hinges 51, 52 and connection arm 53. It is noted that the design can be free of hinges (e.g., see FIG. 5). FIG. 4 illustrates a rear view of the stand of FIG. 1. As shown in FIG. 4, connection arm 53 joins vertical support member 20 and horizontal support member 30. In operation the location of retaining member 40 can be adjusted through manipulation of connection arm 53 via hinges 51, 52.

Vertical support member 20 can have an opening 25 through which horizontal support member 30 passes. Opening 25 can be fully enclosed within vertical support member 20, or open on one side. Through the use of additive manufacturing, it is possible for horizontal support member 30 to have portions with a greater width at points adjacent opening 25 than points passing through opening 25. Thus, a reduction in material can be achieved that would not be possible with multiple piece assemblies or other manufacturing methods. In other words, horizontal support member 30 can include portions that would be too wide to fit through opening 25 at both of its ends (e.g., a generally hour glass shape). Thus, methods such as injection molding would not be capable of forming a stand with horizontal support member 30 at least because horizontal support 30 member would not fit through opening 25. Accordingly, an additive manufacturing process advantageously allows horizontal support member 30 to include portions on both sides of the opening 25 that are wider than opening 25; e.g., the width of the horizontal support member 30 on each side of the opening 25 is greater than the size of the opening 25.

Horizontal support member 30 can include a locking mechanism that corresponds with a corresponding component on vertical support member 20. As illustrated in FIG. 2, horizontal support member 30 can include a plurality of recesses 61 that correspond to a locking tab 62 located on vertical support member 20. In operation, the stand can be adjusted by moving horizontal support member 30 via connection arm 53. In addition, once a suitable position has been selected, the stand can be locked by aligning a particular recess 61 with the locking tab 62 and inserting the locking tab 62 into the recess 61, thereby preventing movement of horizontal support member 30 in at least one direction.

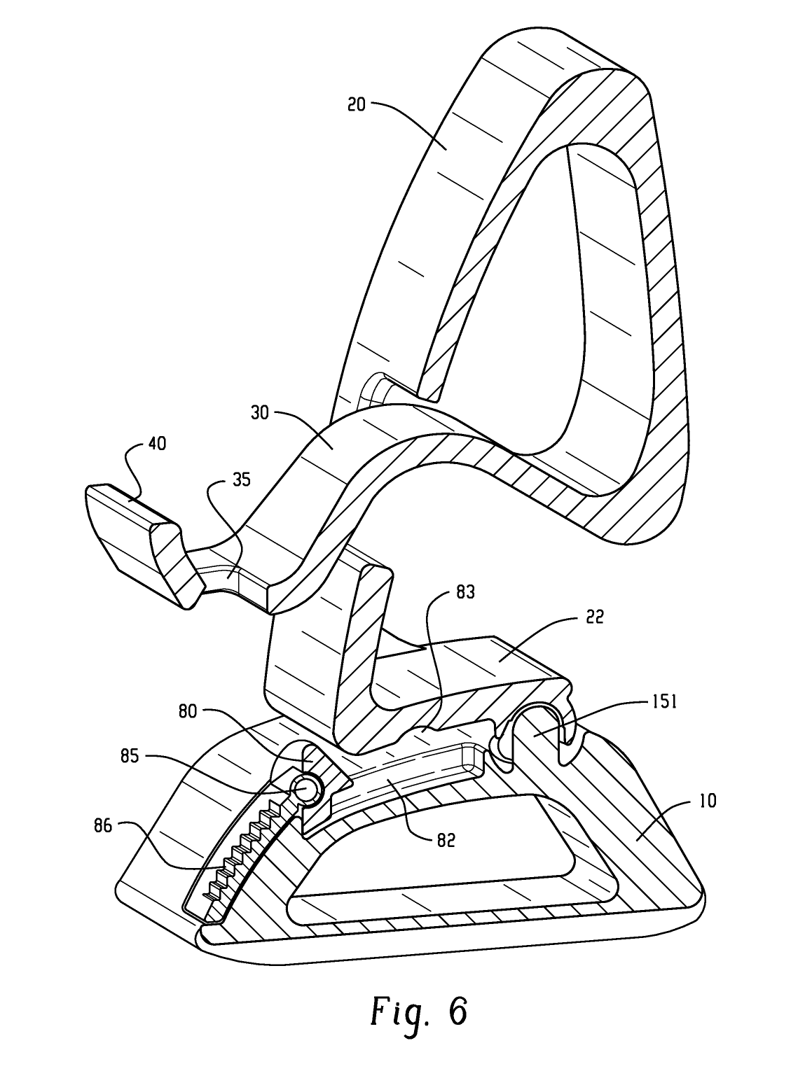

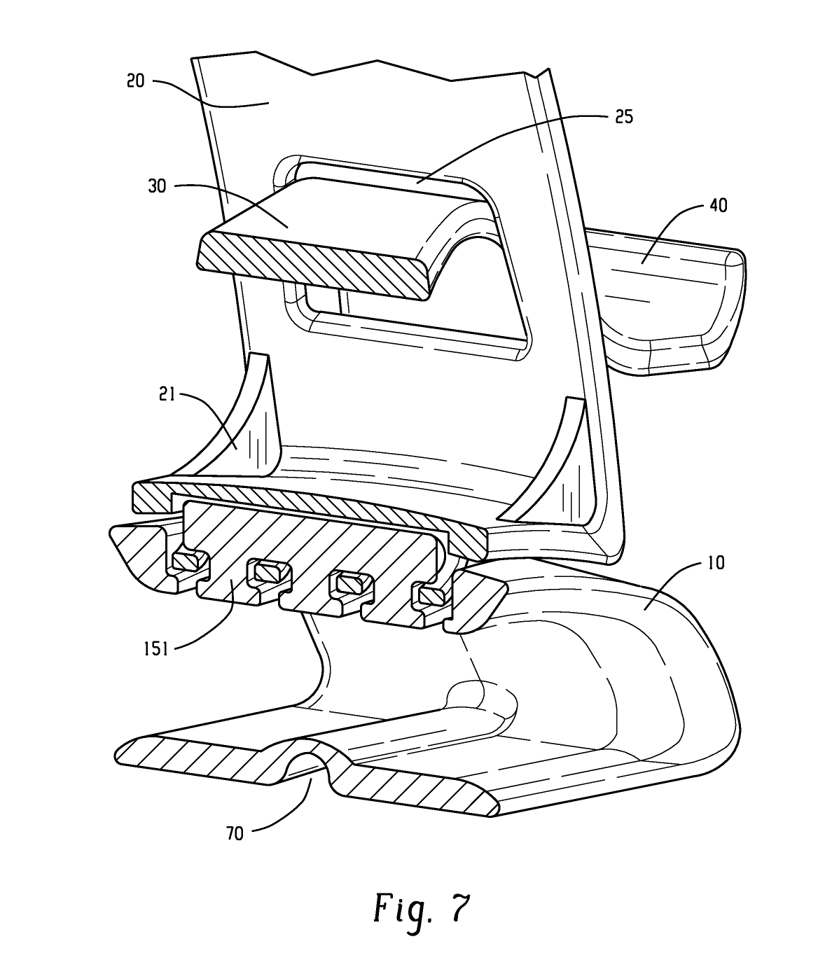

FIGS. 5-7 illustrate an alternative adjustment mechanism. As shown in FIGS. 5-7, the vertical support member, connection arm, and horizontal support member can be hingeless (e.g., with no hinges therebetween). Here, the connection arm 53 which joins vertical support member 20 and horizontal support member 30 is merely a portion of a continuous element. Vertical support member 20 intersects bottom support member 22 (also referred to as the third support member) and includes one or more support ribs 21, which can be located at the intersection of vertical support member 20 and bottom support member 22. Bottom support member 22 can have a lower surface that is complimentary to the upper surface of base 10. As shown in FIG. 6, bottom support member 22 can be joined to base 10 through hinge 151. Base 10 can include track 82, which is sized to accommodate wedge 80. Thus, the adjustment mechanism can include hinge 151, bottom support member 22, wedge 80, and track 82. In operation, retaining member 40 can be moved by sliding wedge 80 along track 82, which allows wedge 80 to move under bottom support member 22, causing bottom support member 22 to pivot on hinge 151. One or more locking recesses 83 can be formed in the bottom surface of bottom support member 22 and configured to receive wedge 80. In operation, the stand can be locked into a position by aligning wedge 80 with a particular locking recess 83 such that the wedge extends into the recess. Wedge 80 is in operable communication with hinge 85 and tab 86. For example, wedge 80 can be moved on track 82 by lifting tab 86 on the axis of hinge 85 and pushing or pulling wedge 80 to a desired position via tab 86.

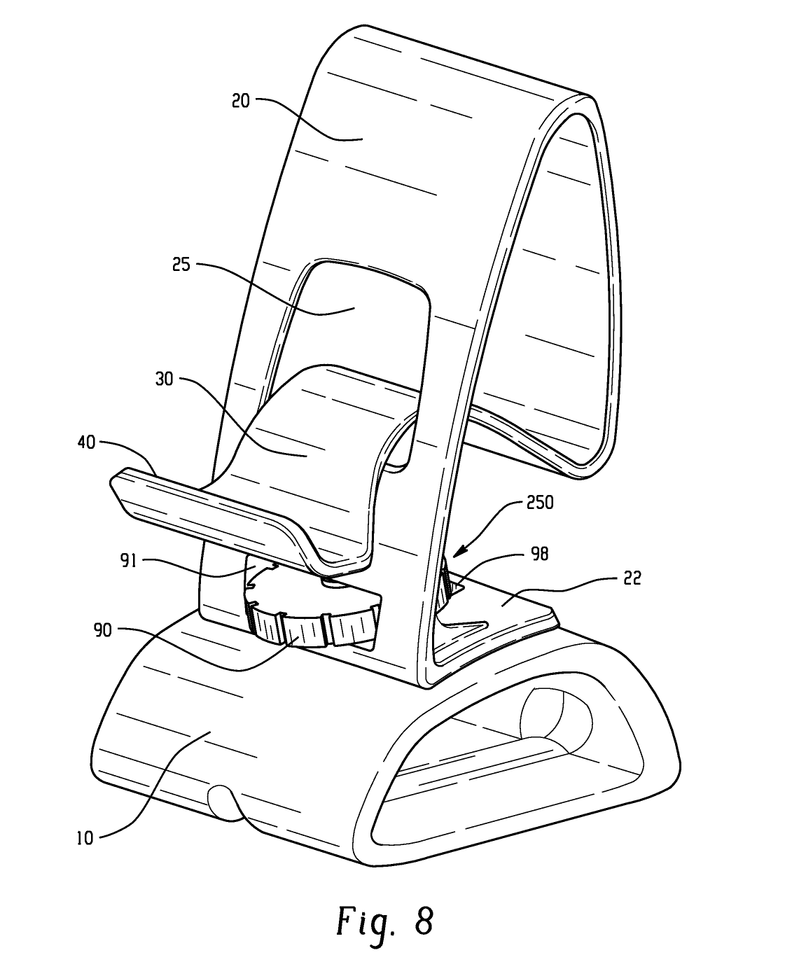

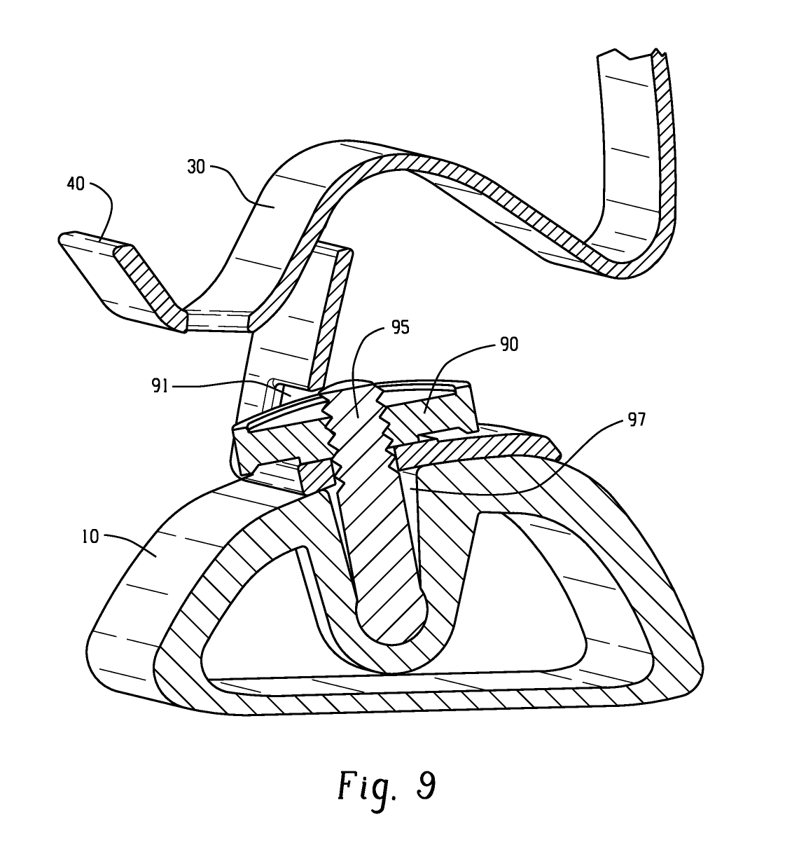

FIGS. 8 and 9 illustrate another adjustment mechanism. Here, adjustment mechanism 250 can include wheel opening 91, adjustment wheel 90, threaded rod 95, recess 97, and bottom support member 22. Vertical support member can include wheel opening 91, which is sized to accommodate an adjustment wheel 90. Adjustment wheel 90 can include a hollow center sized to accommodate threaded rod 95. Bottom support member 22 can include an opening sized to accommodate threaded rod 95 such that movement of threaded rod 95 moves bottom support member 22. Base 10 can include recess 97 with sides that are angled to a greater extent than the sides of threaded rod 95. In other words, there can be a gap between one or both sides of recess 97 and threaded rod 95 when threaded rod 95 is located within recess 97. In addition, the bottom of threaded rod 95 can be rounded to facilitate a pivoting movement against the bottom of recess 97, which can include a rounded geometry complimentary to the bottom of threaded rod 95.

In operation, the turning of wheel 90 in one direction allows for separation between wheel 90, bottom support member 22, and the upper surface of base 10. The separation between these components allows for the movement of threaded rod 95 within recess 97. Adjustment is achieved by the movement of threaded rod 95 within recess 97, which in turn moves bottom support member 22, (hence also moving vertical support member 20 and horizontal support member 30). The stand can be adjusted by positioning retaining member 40 to a desired location through the manipulation of threaded rod 95 within recess 97. Wheel 90 can be turned in the opposite direction, thereby eliminating separation between wheel 90, bottom support member 22, and the upper surface of base 10, locking threaded rod 95 in the desired location within the recess. In other words, the wheel 90 can be turned to engage the bottom support member 22 and retain it in the desired location. Thus, bottom support member 22, vertical support member 20, and horizontal support member 30 are also locked into a desired position.

Alternatively or in addition to recess 97 allowing movement of bottom support member 22 can comprise a slot 98 through which threaded rod 95 extends such that when the wheel 90 is moved to the release position (such that it does not engage the bottom support member 22), the bottom support member 22 can be moved by sliding the threaded rod along the slot 98.

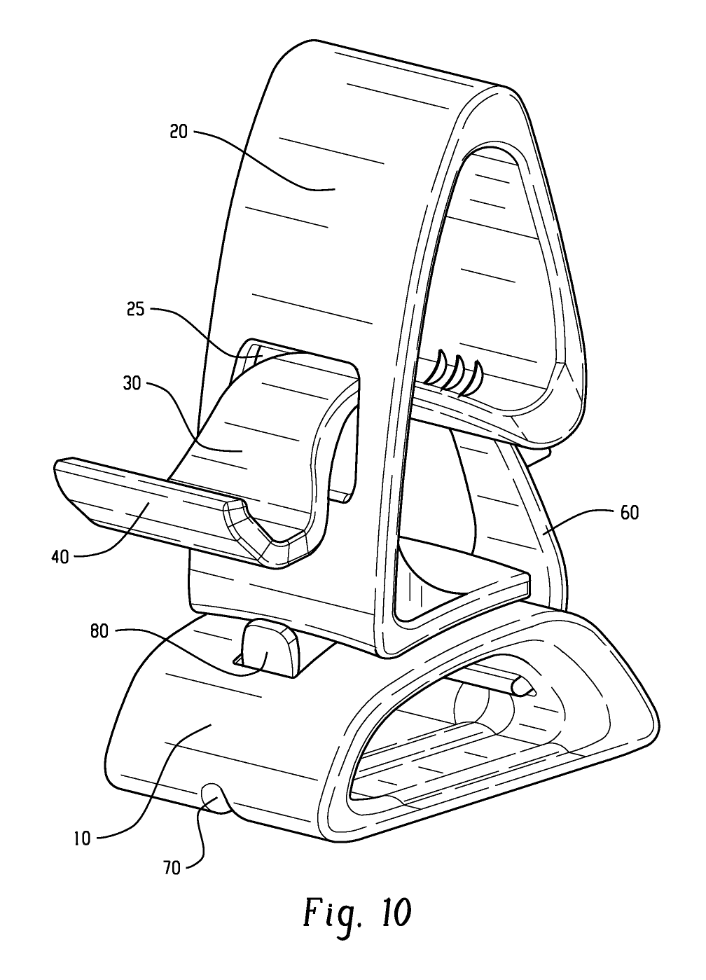

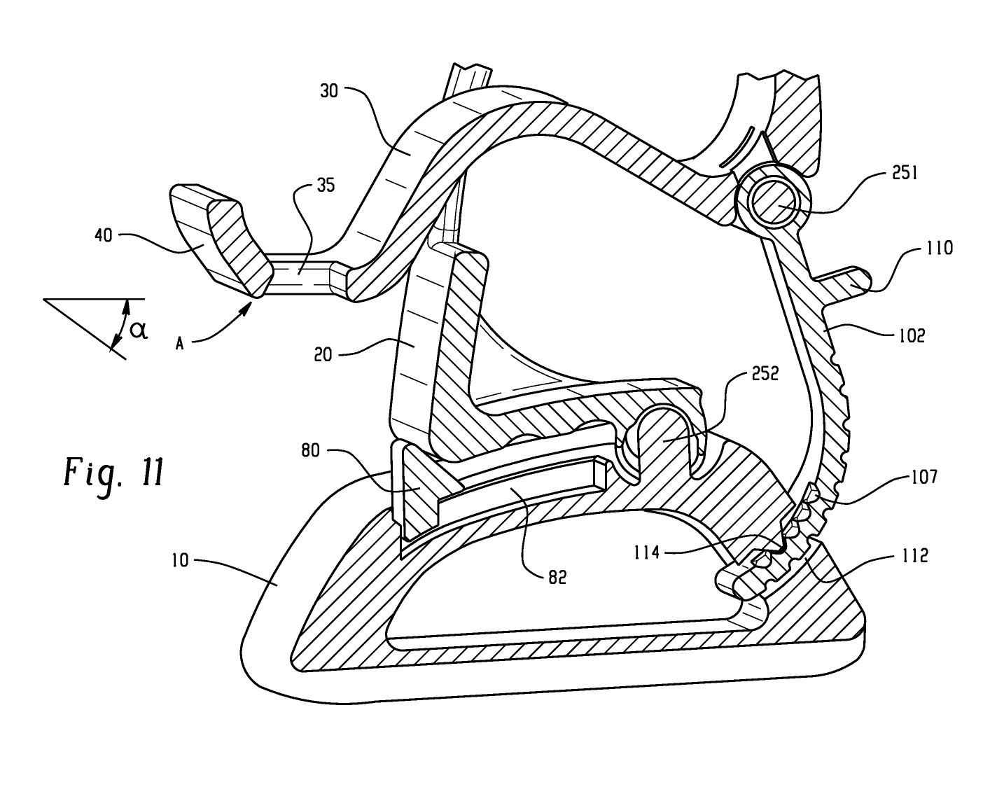

As shown in FIGS. 10 and 11, locking mechanism 60 can include locking arm 102, hinge 251, recess(s) 107, and protrusion 110 (e.g., that can form a handle or grip). In operation, adjustment can be achieved by pressing wedge 80 against bottom support member 22, causing bottom support member 22 to pivot on hinge 252 and causing locking arm 102 to move with respect to the channel 112 in the base 10 by pivoting on hinge 251. The pivoting motion moves retaining member 40 with respect to base 10. When a suitable location for retaining member 40 is selected, a recess 107 can be engaged by projection 114 extending from a wall of the channel 112, retaining the locking arm 102 in the desired position.

Base 10 can include an attachment mechanism for securing the stand to another surface. The attachment mechanism can comprise one or more of a clip, bolt, or similar device for attachment to another surface. In addition, the bottom surface of base 10 can be textured and/or include a weight to reduce slippage on a surface. Additional pieces can be used to further secure base 10 to another surface. For example, base 10 can be configured to house one or more suction cups and/or microsuction cups. In addition, base 10 can include a material with adhesive properties to prevent slippage. The bottom surface of base 10 can be shaped to compliment the shape of the surface to which the stand will be attached. For example, when used on a desk or other flat surface, the bottom surface of base 10 can be flat. When used on a dashboard or a curved surface, the bottom surface of base 10 can be curved to fit the slope or curve of the dashboard.

The various components described above can be used interchangeably. For example, locking mechanism 60 shown in FIG. 10 can be employed with the adjustment mechanism of FIG. 1. In addition, the various components described above can be implemented in an opposite orientation. For example, regarding FIG. 10, protrusion 110 can be located on locking arm 102 and recess 107 can be located on base 10.

The various components described above and/or portions of the components can be made from multiple materials. For example, base 10 can be made of a metallic material and vertical support member 20 can be polymeric. Similarly, the various components described above and/or portions of the components can be different colors. For example, a portion of base 10 can be black, while a portion of vertical support member can be white.

The adjustment mechanisms 50, 150, 250 discussed above allow retaining member 40 to be moved over a range with respect to a horizontal plane, depicted as angle α in FIG. 11. As described herein, the motion of retaining member 40 is measured at a point A depicted in FIG. 11. For example, retaining member 40 can be moved over a range of about 0° to about 45° from a horizontal plane. Specifically, retaining member 40 can be moved over a range of 0° to 30° from a plane parallel to a horizontal plane.

Set forth below are examples of the stand described here.

### Embodiment 1

A stand for holding a device comprising: a base; a first support member oriented in a vertical direction in operable communication with the base; a second support member oriented in a horizontal direction in operable communication with the first support member; a retaining member extending from the second support member and angled in a vertical direction, away from the base; and an adjustment mechanism configured to adjust the location and/or angle of the retaining member; wherein the stand was formed as a one-piece unit that cannot be disassembled.

### Embodiment 2

The stand of Embodiment 1, wherein the second support member is in operable communication with the first support member through a connection member.

### Embodiment 3

The stand of any of Embodiments 1-2, wherein the connection member and first support member are attached together via a first hinge.

### Embodiment 4

The stand of any of Embodiments 1-3, wherein the connection member and second support member are attached together via a second hinge.

### Embodiment 5

A stand for holding a device comprising: a base; a single holding member formed by a first support member oriented in a vertical direction in operable communication with the base, a second support portion oriented in a horizontal direction in operable communication with the first support member, and a connection member connecting the first support member and the second support member, wherein there are no hinges between the first support member, second support member and connection member; a retaining member extending from the second support member and angled in a vertical direction, away from the base; and an adjustment mechanism configured to adjust the location and/or angle of the retaining member; wherein the stand was formed as a one-piece unit that cannot be disassembled.

### Embodiment 6

The stand of any of Embodiments 1-5, wherein the adjustment mechanism comprises a hinge such that the angle of the retaining member can be adjusted.

### Embodiment 7

The stand of any of Embodiments 1-6, wherein the adjustment mechanism is on the base and comprises a wedge and track.

### Embodiment 8

The stand of any of Embodiments 2-7, further comprising a locking mechanism in operable communication with the base and at least one of the connecting member and the second member.

### Embodiment 9

The stand of Embodiment 8, wherein the locking mechanism comprises: a locking member a channel through the base, wherein a wall of the channel comprises a projection configured to engage the recess; a wedge extending from the base, wherein the wedge is configured to move along a track and thereby contact a third support member that extends from the first support member along the base to a base hinge. The locking member comprises a protrusion extending away from the base to enable manual adjustment of the locking member with respect to the base, and a plurality of recesses located between the protrusion and an end of the locking member that extends through the base.

### Embodiment 10

The stand of any of Embodiments 1-8, further comprising a third support member that extends from the first support member along the base to a base hinge; a wedge extending from the base, wherein the wedge is configured to move along a track in the base, below the third support member and change the orientation of the first support member; and a locking recess configured to receive the wedge.

### Embodiment 11

The stand of Embodiment 10, further comprising a tab connected to the wedge with a tab hinge, wherein the tab is configured to rotate about the tab hinge to a use position wherein pressure on the tab pushes the wedge along the track, or pulls the wedge along the track.

### Embodiment 12

The stand of any of Embodiments 10-11, wherein the locking member is in operable communication with at least one of the connecting member and the second member via a locking member hinge.

### Embodiment 13

The stand of any of Embodiments 1-12, wherein the adjustment mechanism comprises an opening though the third support member; a recess in the base, adjacent to the opening in the third support member; a threaded rod extending through the opening and into the recess; and a wheel on the threaded rod with the third support member located between the threaded wheel and the base; wherein the wheel can be moved along the threaded rod to engage and retain the third support member in a location, and can be moved to release the third support member such that the base can be moved to change the angle of the first support member.

### Embodiment 14

The stand of Embodiment 13, wherein the wheel extends through a wheel opening in the first support member, and wherein the opening has a size insufficient for the wheel to be removed from the rod.

### Embodiment 15

The stand of any of Embodiments 13-14, wherein the recess has a size larger than a diameter of the threaded rod such that when the wheel disengages the third support member the rod can be tilted toward and/or away from the first support member, thereby moving the third support member.

### Embodiment 16

The stand of any of Embodiments 13-14, wherein the third support member comprises a slot, and wherein the threaded rod extend through the slot such that when the wheel disengages the third support member the location of the threaded rod in the slot can be adjusted.

### Embodiment 17

The stand of any of Embodiments 1-16, further comprising a third support member in operable communication with the base and the vertical support member, and a rib extending between the first support member and the third support member.

### Embodiment 18

The stand of any of Embodiments 1-17, wherein the second support member extends through an opening through the first support member, wherein the opening has an opening size, and wherein the second support member has a size on each side of the opening that is larger than the opening size.

### Embodiment 19

The stand of any of Embodiments 1-18, wherein the second support member comprises an aperture through the retaining member.

### Embodiment 20

The stand of any of Embodiments 1-19, wherein the base comprises a notch across a bottom surface extending from the front of the base to the rear of the base and sized to receive a cord.

### Embodiment 21

The stand of any of Embodiments 1-20, wherein stand is configured to receive an electronic device selected from a digital music player, a digital video player, a digital music and video player, a cellular phone, a personal digital assistant, a handheld digital computer, and a combination comprising at least one of the foregoing.

### Embodiment 22

A stand for holding a device comprising: a base; a first support member oriented in a vertical direction in operable communication with the base; a second support member oriented in a horizontal direction in operable communication with the first support member; wherein the second support member comprises retaining member angled away from the second support member in a vertical direction; wherein at least one of the base, first support member, and second support member comprises an adjustment mechanism allowing for the adjustment of the location of the retaining member; wherein the stand comprises a one-piece unit.

In general, the invention may alternately comprise, consist of, or consist essentially of, any appropriate components herein disclosed. The invention may additionally, or alternatively, be formulated so as to be devoid, or substantially free, of any components, materials, ingredients, adjuvants or species used in the prior art compositions or that are otherwise not necessary to the achievement of the function and/or objectives of the present invention.

All ranges disclosed herein are inclusive of the endpoints, and the endpoints are independently combinable with each other (e.g., ranges of “up to 25 wt %, or, more specifically, 5 to 20 wt %”, is inclusive of the endpoints and all intermediate values of the ranges of “5 to 25 wt %,” etc.). “Combination” is inclusive of blends, mixtures, alloys, reaction products, and the like. Furthermore, the terms “first,” “second,” and the like, herein do not denote any order, quantity, or importance, but rather are used to denote one element from another. The terms “a” and “an” and “the” herein do not denote a limitation of quantity, and are to be construed to cover both the singular and the plural, unless otherwise indicated herein or clearly contradicted by context. The suffix “(s)” as used herein is intended to include both the singular and the plural of the term that it modifies, thereby including one or more of that term (e.g., the film(s) includes one or more films). Reference throughout the specification to “one embodiment,” “another embodiment,” “an embodiment,” and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments. “Optional” or “optionally” means that the subsequently described event or circumstance can or cannot occur, and that the description includes instances where the event occurs and instances where it does not.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

While typical embodiments have been set forth for the purpose of illustration, the foregoing descriptions should not be deemed to be a limitation on the scope herein. Accordingly, various modifications, adaptations, and alternatives can occur to one skilled in the art without departing from the spirit and scope herein.

What is claimed is:

1. A stand for holding a device comprising:
a base;
a first support member oriented in a vertical direction in operable communication with the base, wherein the first support member has an opening having an opening size;
a second support member oriented in a horizontal direction in operable communication with the first support member;
a retaining member extending from the second support member and angled in a vertical direction, away from the base; and
an adjustment mechanism connecting the first support member and the second support member, and configured to adjust at least one of a location and an angle of the retaining member;
wherein the second support member has a size on each side of the opening that is greater than the opening size;
wherein the stand was formed as a one-piece unit that cannot be disassembled.

2. The stand of claim 1, wherein the second support member is in operable communication with the first support member through a connection member.

3. The stand of any claim 1, wherein the connection member and first support member are attached together via a first hinge, and the connection member and second support member are attached together via a second hinge.

4. The stand of claim 1, further comprising a locking mechanism in operable communication with the base and at least one of the connecting member and the second support member.

5. The stand of claim 4, wherein the locking mechanism comprises
a locking member comprising
a protrusion extending away from the base to enable manual adjustment of the locking member with respect to the base; and
a plurality of recesses located between the protrusion and an end of the locking member that extends through the base;
a channel through the base, wherein a wall of the channel comprises a projection configured to engage the recess; and
a wedge extending from the base, wherein the wedge is configured to move along a track and thereby contact a third support member that extends from the first support member along the base to a base hinge.

6. A stand for holding a device comprising:
a base;
a single holding member formed by a first support member oriented in a vertical direction in operable communication with the base, a second support portion oriented in a horizontal direction in operable communication with the first support member and extending through an opening in the first support member, and a connection member connecting the first support member and the second support member, wherein there are no hinges between the first support member, second support member and connection member;
a retaining member extending from the second support member and angled in a vertical direction, away from the base; and
an adjustment mechanism configured to adjust the location and/or angle of the retaining member;
wherein the opening has an opening size and the second support portion has a size on each side of the opening that is greater than the opening size; and
wherein the stand was formed as a one-piece unit that cannot be disassembled.

7. The stand of claim 6, wherein the adjustment mechanism is on the base and comprises a wedge and track.

8. The stand of claim 6, further comprising
a third support member that extends from the first support member along the base to a base hinge;
a wedge extending from the base, wherein the wedge is configured to move along a track in the base, below the third support member and change the orientation of the first support member; and
a locking recess configured to receive the wedge.

9. The stand of claim 8, further comprising a tab connected to the wedge with a tab hinge, wherein the tab is configured to rotate about the tab hinge to a use position wherein pressure on the tab pushes the wedge along the track, or pulls the wedge along the track.

10. The stand of claim 8, wherein the locking member is in operable communication with at least one of the connecting member and the second support member via a locking member hinge.

11. The stand of claim 6, wherein the adjustment mechanism comprises
an opening though the third support member;
a recess in the base, adjacent to the opening in the third support member;
a threaded rod extending through the opening and into the recess; and
a wheel on the threaded rod with the third support member located between the threaded wheel and the base;
wherein the wheel can be moved along the threaded rod to engage and retain the third support member in a location, and can be moved to release the third support member such that the base can be moved to change the angle of the first support member.

12. The stand of claim 11, wherein the wheel extends through a wheel opening in the first support member, and wherein the opening has a size insufficient for the wheel to be removed from the rod.

13. The stand of claim 11, wherein the recess has a size larger than a diameter of the threaded rod such that when the wheel disengages the third support member the rod can be tilted toward and/or away from the first support member, thereby moving the third support member.

14. The stand of claim 11, wherein the third support member comprises a slot, and wherein the threaded rod extend through the slot such that when the wheel disengages the third support member the location of the threaded rod in the slot can be adjusted.

15. The stand of claim 11, further comprising a third support member in operable communication with the base and the vertical support member, and a rib extending between the first support member and the third support member.

16. The stand of claim 1, further comprising an aperture through the retaining member.

17. The stand of claim 11, wherein the base comprises a notch across a bottom surface of the base and extending from the front of the base to the rear of the base and sized to receive a cord.

18. The stand of claim 1, wherein stand is configured to receive an electronic device selected from a digital music player, a digital video player, a digital music and video player, a cellular phone, a personal digital assistant, a handheld digital computer, and a combination comprising at least one of the foregoing.

19. A stand for holding a device comprising:
a base comprising a notch across a bottom surface of the base and extending from the front of the base to the rear of the base and sized to receive a cord;
a first support member oriented in a vertical direction in operable communication with the base, wherein the first support member has an opening having an opening size;
a second support member oriented in a horizontal direction in operable communication with the first support member;
a retaining member with an aperture therethrough, wherein the retaining member extends from the second support member and angled in a vertical direction, away from the base; and
an adjustment mechanism comprising a connection member that connects the first support member and the second support member, wherein the adjustment mechanism is configured to adjust at least one of a location and an angle of the retaining member, wherein the connection member and first support member are attached together via a first hinge, and the connection member and second support member are attached together via a second hinge;
wherein the second support member has a size on each side of the opening that is greater than the opening size;
wherein the stand was formed as a one-piece unit that cannot be disassembled.

20. The stand of claim 19, wherein the locking mechanism comprises
a locking member comprising
a protrusion extending away from the base to enable manual adjustment of the locking member with respect to the base; and
a plurality of recesses located between the protrusion and an end of the locking member that extends through the base;
a channel through the base, wherein a wall of the channel comprises a projection configured to engage the recess; and
a wedge extending from the base, wherein the wedge is configured to move along a track and thereby contact a third support member that extends from the first support member along the base to a base hinge.
